(19) United States
(12) Patent Application Publication
(10) Pub. No.: US 2010/0000472 A1
(43) Pub. Date: Jan. 7, 2010

(54) SEAT BELT LOOP SYSTEM FOR A PET CARRIER

(76) Inventor: Tibor Siklosi, Joplin, MO (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/167,730

(22) Filed: Jul. 3, 2008

(51) Int. Cl. A01K 1/03; F16G 3/00

(52) U.S. Cl. 119/497; 24/32

(57) ABSTRACT

A seat belt loop system for use with an animal/pet carrier in order to transport an animal in a moving vehicle. The seat belt loop system includes an anchor tab coupled to the pet carrier, a cinch strap coupled to the anchor tab, and cinch strap with a proximal end coupled to the pet carrier and a distal end for insertion through the cinch loop. Once inserted, the distal end is cinched against the cinch loop and then coupled to the cinch strap. A fastening mechanism on the cinch strap is engaged to retain a vehicle seat belt between the pet carrier and the seat belt loop.

### FIELD OF THE INVENTION

The present invention relates generally to devices for the care and maintenance of animals and pets. More specifically, the present invention relates to devices used to transport animals and particularly pets.

### BACKGROUND OF THE INVENTION

Animal transportation devices such as pet carriers are known in the art for the purpose of transporting animals and particularly domesticated animals such as cats and dogs (pets). Pet carriers of rigid construction, such as metal and then plastic have long been used to transport a pet in a vehicle such as a car, bus, train, or airplane. These rigid pet carrier designs were box-shaped structures and were typically cage-like or enclosed with a cage door or gate for access. The rigid construction and/or size made these carriers cumbersome for transport purposes and their designs did not lend themselves well for transport on the vehicle passenger seating surfaces wherein such carriers would be subject to tipping (typically top heavy/unstable with a pet inside) or sliding from the seat when subject to forces of inertia in the moving vehicle. As a result, they were most often transported in the rear cargo areas of station wagons and then SUV's, or perhaps in footwells, depending on the size. In commercial passenger vehicles, they were either placed under the seats in planes, trains, or busses in they were small enough (for a small pet) or commonly placed in the cargo hold. In some part due to these design and transport limitations of rigid carriers, and historical ignorance of safety concerns of pets during transport, these carriers were rarely restrained during transport.

Advances in the art have recognized the fact that pet carriers of a rigid construction are difficult to transport. As a result, pet carriers of a flexible construction have become popular. Several of such flexible designs are constructed of fabric and mesh materials and resemble handbags, duffle bags, or luggage. These flexible designs are much easier to transport because they are lighter, not box-like with rigid corners, since they have the ability to be manipulated for placement in vehicles and under vehicle seats. Importantly, however, these flexible designs, since they are typically smaller and less top-heavy than rigid designs, are amenable to placement and transport on the vehicle passenger seating surfaces.

Although flexible pet carriers are more amenable to placement on passenger seating surfaces during transport and are more stable than rigid designs, an unrestrained pet carrier will still be subject to the same forces of momentum and inertia as any unrestrained object in a moving vehicle. As a result of this fact, coupled with the increasing understanding of the safety needs of pets during vehicle transport, a need exists for a pet carrier, and thus the pet inside, that can be restrained during vehicle transport.

Almost all passenger vehicles have seat belts of some sort, some with shoulder straps and some without. As a result, many pet carrier designs attempt to allow engagement with the existing seat belt restraint system of the vehicle. Known designs, however, employ either loops of some sort typically associated with the carry straps of the pet carrier or provide a rigid frame/handle that allows a seat belt to be inserted between the rigid frame/handle and the flexible carrier. It has been found to be often difficult to insert the seat belt through the loop(s) or between the rigid frame/handle and the flexible carrier in order to properly restrain the pet carrier (and thereby the pet) in the vehicle particularly in the case of a three-point seat belt. As a result, such systems sometimes go unused.

In the case of the carry strap loop, it is evident that the loop segment represents a portion of the strap that is not secured to the flexible carrier, resulting in a weaker coupling between the strap and the carrier. In addition, the loops over time often become stretched, thereby providing a loose coupling (allows play) between the vehicle seat belt restraint system and the flexible pet carrier.

A need, therefore, exists for a seat belt loop system for a flexible pet carrier which does not affect the structural coupling between the carry strap and the flexible bag and is also capable of being tightened, or cinched, around the vehicle seat belt in order to provide a secure coupling an thereby eliminate play.

### SUMMARY OF THE INVENTION

A seat belt loop coupling system for use with an animal and preferably pet carrier used to transport an animal (pet) in a vehicle such as a plane, train, bus, or car. The seat belt loop system includes, generally, an anchor tab carrier, a cinch loop, and a cinch strap. The seat belt loop system disclosed herein is intended for engagement with the seat belt restraint system of the vehicle and is capable of use with a lap belt, a three point seat belt, or other known vehicle seat belt restraint devices.

The anchor tab is coupled to the pet carrier. As used herein, the term “coupled” may mean any method of attachment and may be either permanently applied or removable unless otherwise specified. In addition, coupled to the pet carrier could either mean directly coupled, such as to the wall of the pet carrier (flexible or rigid) or connected to a carry strap integrated into the carry strap. Coupled to the pet carrier could also mean connected indirectly, such as connected to a carry strap which is separate from and/or an accessory for a pet carrier.

The cinch loop is coupled to the anchor tab. In an alternate, basic embodiment, the cinch loop may be coupled directly to the pet carrier, thus eliminating the anchor tab. It is contemplated in the present disclosure that the anchor tab may include a cinch loop or the cinch loop may include an anchor tab. The cinch loop coupled to the pet carrier (or anchor tab) receives the cinch strap for slideable engagement therein.

The cinch strap includes a proximal end and a distal end. The proximal end is coupled to the pet carrier such that the distal end is capable of extending through the cinch loop.

The proximal end of the cinch loop is coupled to the pet carrier in a position and at a distance from the anchor tabs and/or cinch loop sufficient to allow a seat belt of a vehicle to be positioned between the proximal end of the cinch strap and the anchor tab. Once secured, the vehicle seat belt is retained therein.

The cinch strap is of a length sufficient to insert the distal end through the cinch loop. The distal end is slid through the cinch loop and pulled or cinched tightly, as desired, against the cinch loop and pulled back toward the proximal end. The cinch strap includes means for removably coupling the distal end to the cinch strap. The means for coupling is a fastening mechanism which allows the cinch strap to be slid through the cinch loop, cinched to the desired tension, and then engaged to maintain the desired tension. The coupling mechanism could be of any design, including but not limited to, buttons, clasps, snaps, or buckles. The means for removably coupling/fastening mechanism is preferably a hook and loop fastening system where the hook segment may be positioned on the distal end of the cinch strap and the loop segment is positioned on the cinch strap.

When the distal end of the cinch strap is inserted through the cinch and cinched tight, the hook and loop fastening system is engaged. When the coupling mechanism is engaged, the vehicle seat belt is retained between the pet carrier and the seat belt loop of the present disclosure.

As used herein, the term “retained” means to be bounded and held. In the preferred embodiment, the vehicle seat belt is retained between the seat belt loop of the present disclosure and the pet carrier (or carry strap of the pet carrier). In this way, the ability of the seat belt loop system of the present disclosure to cinch and engage, avoids movement or play between the seat belt loop system and the seat belt. The vehicle seat belt may move or slide laterally between the seat belt loop and the pet carrier or cinched so as to restrict such lateral movement.

Multiple seat belt loop systems may be coupled to and positioned along the pet carrier in order to provide additional support and stability. When the pet carrier is placed on the passenger seating surface of the vehicle, a vehicle seat belt is retained in the present seat belt loop system, the pet carrier is restrained against momentum and inertial forces of the moving vehicle and held in place on the seat.

### BRIEF DESCRIPTION OF THE DRAWINGS

FIG. 1 depicts a side view of a representative flexible pet carrier including the seat belt loop system of the present disclosure engaging a vehicle seat belt.

FIG. 2 depicts an end view of a representative flexible pet carrier including the seat belt loop system of the present disclosure.

FIG. 3 is an isometric view of the seat belt loop system of the present disclosure coupled to a carry strap of a flexible pet carrier and engaging a vehicle seat belt.

### DETAILED DESCRIPTION OF THE PREFERRED EMBODIMENT

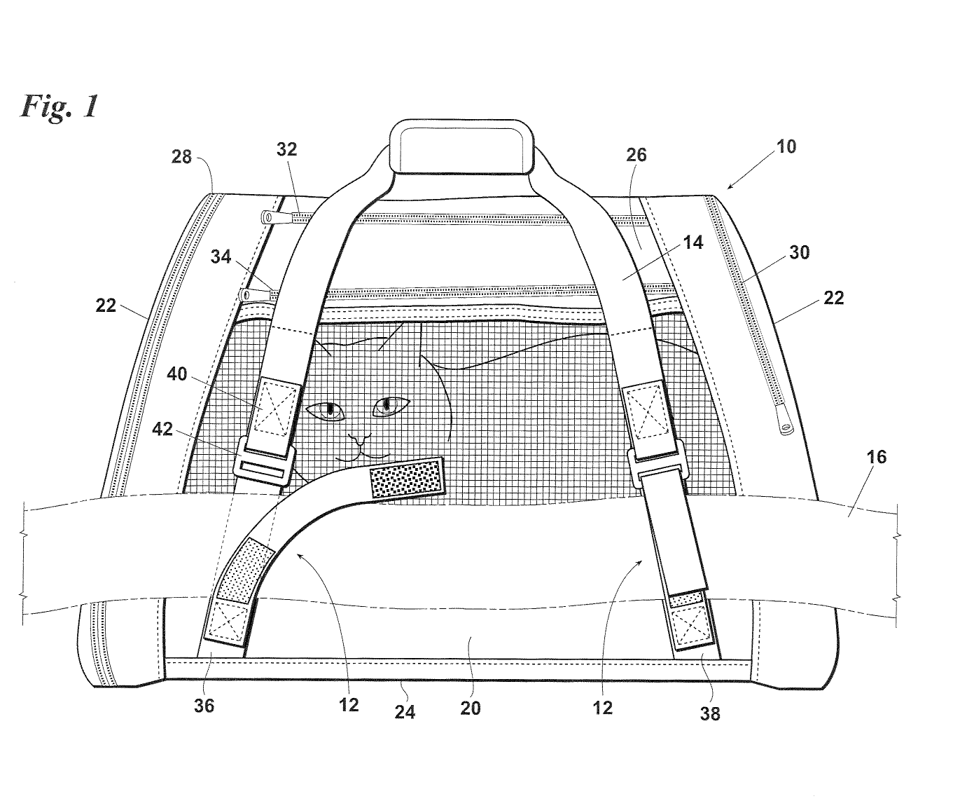

Referring to FIG. 1, an animal and preferably pet carrier 10 used to transport an animal in a vehicle such as a plane, train, bus, or car is shown. Pet carrier 10 includes a seat belt loop system 12 for engagement with the seat belt restraint system of the vehicle. As shown in FIG. 1, pet carrier 10 includes a second, identical seat belt loop system 12′ depicted in a fastened arrangement around seat belt 16. Seat belt loop system 12 (and 12′) is capable of use with a vehicle lap belt, a three point seat belt or any other vehicle seat belt restraint system wherein the seat belt loop system can retain a seat belt. However, in a preferred embodiment, the seat belt loop system 12 (and 12′) retains and engages a lap belt 16.

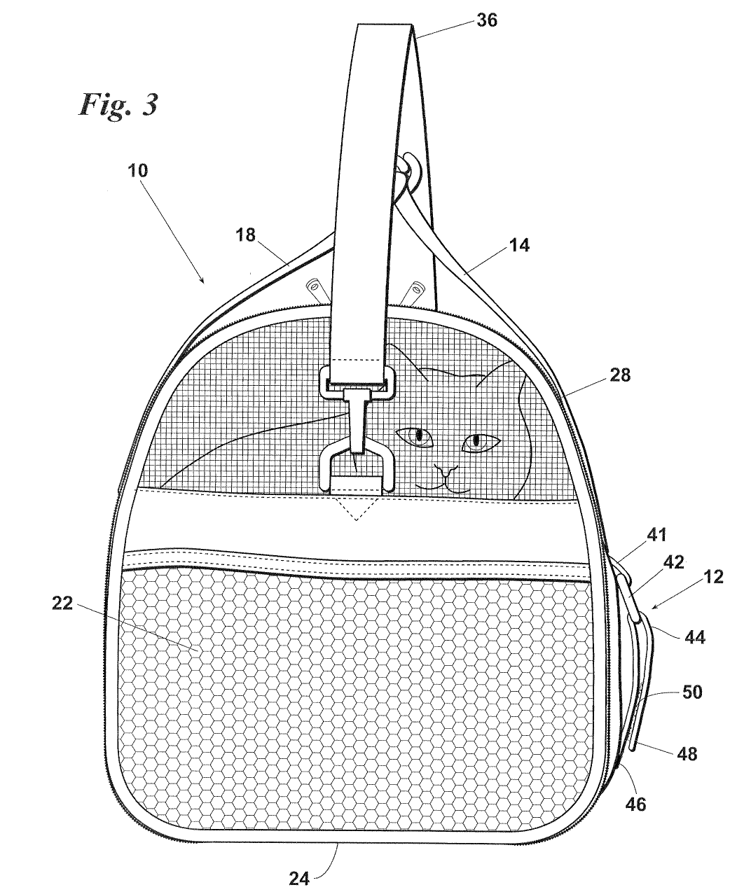

With reference to FIG. 1, taken in combination with FIG. 3, there is shown portable animal/pet carrier 10 which is of a flexible-wall construction. Pet carrier 10 is shown to completely contain a pet therein for travel purposes, such as travel in a moving vehicle which may include taking the pet to the vet or boarding house, bus, train, or airplane travel or other similar travel which requires the pet to travel in a moving vehicle.

Pet carrier 10 includes two elongated sides 20, two short sides 22, a bottom 24, and a top 26, all of which are sized to accommodate an animal therein. Preferably, the bag is sized to accommodate a small dog or a cat (as depicted) but may be of any desired size. The two elongated sides 20, two short sides 22, bottom 24, and top 26 combine to form a housing structure to contain the animal.

Pet carrier 10 includes an opening 28 which extends across top 26 and around the periphery of one short side 22 for substantially the entire length thereof such that the short side 22 folds away to form a door. Opening 28 is used for entry and exit of the pet to/from pet carrier 10. A closure mechanism suitable in the industry for pet applications may be positioned in a fully open state, a fully closed state, or any intermediate position. Examples of such are zippers, hook and loop fasteners (Velcro), etc. Preferably, non-corrosive zippers are used. In a most preferred embodiment, twin zippers are utilized. Pet carrier 10 may include additional openings, such as opening 30 adjacent the second of the two short sides 22. Opening 30 may extend the length of short side 22 or may be shorter to provide restricted access to the interior of pet carrier housing 10. Top 26 may also include a pair of zippered openings 32 and 34 in order to allow access, or partial access to the interior of the housing 10.

The sides of the bag may take many forms and their specific external dimensions or shape do not form a critical part of the present invention. Although the shape of the bag of FIG. 1 shows a bag having a rectangular bottom 24 and generally elongated sides 20, and two short sides 22, the pet carrier 10 may be of many alternate constructions to receive a seat belt loop system of the present disclosure. The pet carrier 10 can be assembled by any of various techniques known in the art. For example, the most common method would be by stitching of adjacent edges. Once in its final assembled configuration, the flexible pet carrier 10 is preferably capable of securely housing and containing an animal in its entirety therein. The interior of the pet carrier 10 forms an enclosed environmental living space for the animal.

In the preferred embodiment, pet carrier 10 also includes a carry strap 14 and 18 secured to each of the elongated sides 20. Although carry straps 14 and 18 are secured to pet carrier 10 in an identical manner, discussion will focus on carry strap 14. Carry strap 14 includes a first end 36 and a second end 38. First end 36 of carry strap 14 is coupled to elongated side panel 20 adjacent to short side panel 22. The second end of carry strap 14 is coupled to elongated side panel 20 adjacent short side panel 22′. Carry straps 14 and 18 are securely coupled, preferably by sewing, to the flexible housing of pet carrier 10 so as to provide a secure method of carrying pet carrier 10.

In the preferred embodiment, the seat belt loop system disclosed herein is coupled to the flexible elongated side wall 20 of pet carrier 10.

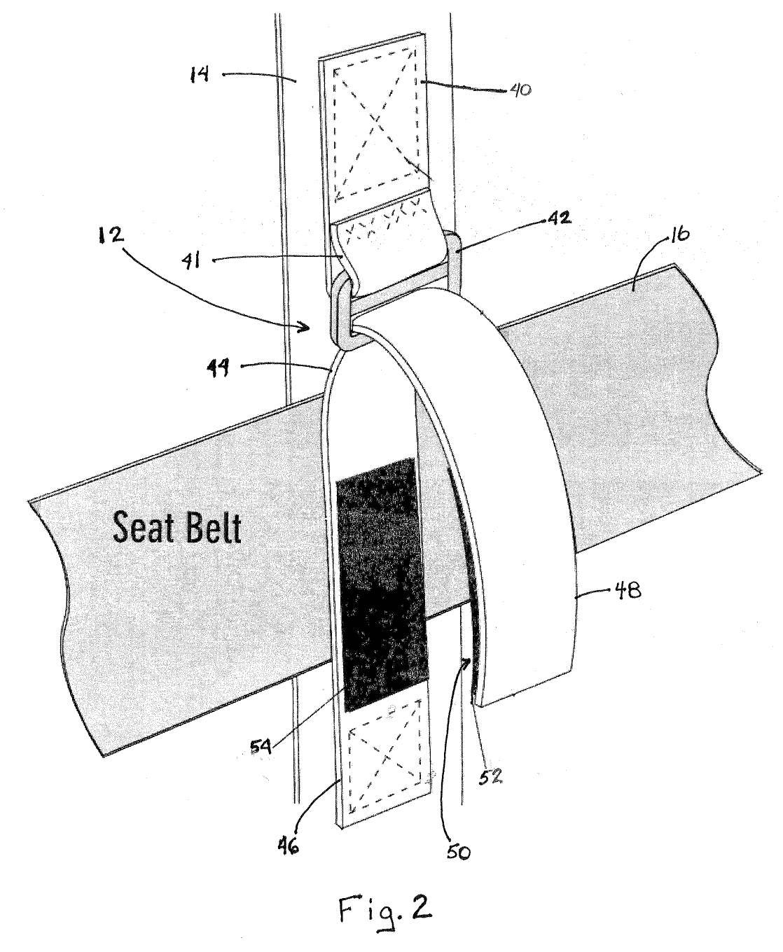

With reference to FIG. 2, a detailed, isometric, view of the seal belt loop system 12 of the present disclosure is shown. Seat belt loop system 12 includes an anchor tab 40, a cinch loop 42, and a cinch strap 44.

The anchor tab 40 is coupled to the pet carrier 10. In the preferred embodiment, anchor tab 40 is coupled to pet carrier 10 by stitching, or sewing anchor tab 40 to carry strap 14, however other means of securing anchor tab 40 to pet carrier 10 are contemplated, including removable means such as hook and loop (Velcro) or other known means. In addition, anchor tab 40 may be coupled to pet carrier 10 directly coupled, such as by being stitched, or sewn, to the wall of the pet carrier 10 or connected to carry strap 14 as depicted.

The cinch loop 42 is coupled to anchor tab 40. In the preferred embodiment, cinch loop 42 is a slip lock buckle and most preferably a tri-glide buckle, however, any known cinch loop design capable of being coupled to the anchor tab 40 and capable of receiving the cinch strap 44 could be substituted. Anchor tab 40 includes an extending segment 41 which is inserted through cinch loop 42 thereby essentially coupling cinch loop 42 to pet carrier 10. It is contemplated in the present disclosure that the anchor tab may include a cinch loop or the cinch loop may include an anchor tab. Cinch loop 42 coupled to pet carrier 10 (through anchor tab 40) receives the cinch strap 44 for slideable engagement therein.

Cinch strap 44 includes a proximal end 46 and a distal end 48. Proximal end 46 is coupled to pet carrier 10 such that the distal end 48 extends therefrom and is of a sufficient length so as to be capable of extending through cinch loop 42. In the preferred embodiment, proximal end 46 of cinch strap 44 is coupled to pet carrier 10 by stitching, or sewing proximal end 46 to carry strap 14, however other means of securing proximal end 46 to pet carrier 10 are contemplated, including removable means such as hook and loop (Velcro) or other known means. In addition, proximal end 46 may be coupled to pet carrier 10 directly, such as by being stitched, or sewn, to the wall of the pet carrier 10 or connected to carry strap 14 as depicted.

Proximal end 46 of cinch strap 44 is coupled to pet carrier 10 in a position and at a distance from the anchor tab 40 (and/or cinch loop 42) sufficient to allow a seat belt 16 of a vehicle to be positioned between proximal end 46 of cinch strap 44 and anchor tab 40. Once secured, the vehicle seat belt 16 is retained therein.

Cinch strap 44 is of a length sufficient to insert distal end 48 through cinch loop 42. Distal end 48 is slid through cinch loop 42 and pulled or cinched tightly, as desired, against, or in relation to, cinch loop 42 and pulled back toward proximal end 46 and capable of being removably fastened to cinch strap 44 (itself).

Cinch strap 44 includes means 50 for removably coupling distal end 48 to cinch strap 44 as depicted in FIG. 2. The means for coupling 50 is a fastening mechanism which allows cinch strap 44 to be slid through cinch loop 42, drawn or cinched to the desired tension, and then engaged to maintain the desired tension thereby retaining seat belt 16. Coupling mechanism 50 could be of any suitable configuration, including but not limited to, buttons, clasps, snaps, or buckles. In the preferred embodiment, the means for removably coupling/fastening mechanism 50 is a hook and loop fastening system where the hook segment 52 may be positioned on the distal end 48 of cinch strap 44 and the loop segment 54 positioned on cinch strap 44. When distal end 48 is inserted through cinch loop 42 and cinched to the desired tension, it is looped back over cinch strap 44 and the hook segment 52 is positioned adjacent the loop segment 54 on cinch strap 44 for engagement therewith.

When distal end 48 of cinch strap 44 is inserted through cinch loop 42 and cinched tight, the hook and loop fastening system 50 is engaged. When fastening mechanism 50 is engaged, vehicle seat belt 16 is retained between the elongated side 20 of the housing of pet carrier 10 and the cinch strap 44 of seat belt loop 12 of the present disclosure. In the preferred embodiment, the vehicle seat belt 16 is retained between the cinch strap 44 of the seat belt loop 12 of the present disclosure and pet carrier 10 (or carry strap 14 of pet carrier 10). In this way, the ability of the seat belt loop system 12 of the present disclosure to cinch and engage avoids movement or play between the seat belt loop system 12 and the seat belt 16. However, the vehicle seat belt 16 may move or slide laterally between the seat belt loop and the pet carrier.

Anchor tab 40 and cinch strap 44 can be constructed of any suitable material. Preferably anchor tab 40 and cinch strap 44 are webbing material commonly of nylon, polyester, or polypropylene but could also be cotton, leather, or any other known natural or synthetic material.

It is contemplated that a plurality of seat belt loop systems 12 will be coupled to, and positioned along the pet carrier in order to provide additional support and stability. Referring to FIG. 1, two such seat belt loop systems 12 and 12′ are coupled to carry strap 14 and thereby elongated side 20 of the housing of pet carrier 10. In this arrangement, when pet carrier 10 is placed on the passenger seating surface of the vehicle, vehicle seat belt 16 is retained in the present seat belt loop systems 12 and 12′, the pet carrier is thus restrained against momentum and inertial forces of the moving vehicle and held in place on the seat.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A loop system for a pet carrier to engage a vehicle seat belt comprising:
an anchor tab coupled to the pet carrier;
a cinch loop coupled to said anchor tab;
a cinch strap having a proximal end and a distal end wherein said proximal end is coupled to said pet carrier;
said distal end of said cinch strap being capable of insertion through said cinch loop;
a coupling mechanism to couple said distal end of said cinch strap to said cinch strap;

2. The loop system of claim Al further including a carry strap coupled to the pet carrier and the anchor tab and proximal end of said cinch strap are coupled to said carry strap.

3. The loop system of claim Al wherein said proximal end of said cinch strap is coupled to the pet carrier a distance from said anchor tab sufficient to allow the seat belt to be positioned between said proximal end of said cinch strap and said anchor tab.

4. The loop system of claim A1 wherein said distal end of said cinch strap is removably coupled to said cinch strap.

5. The loop system of claim A1 wherein said cinch loop is a slip lock buckle.

6. The loop system of claim A1 wherein said coupling mechanism is a hook and loop fastening system.

7. A loop system for a pet carrier to engage a seat belt of a vehicle, said loop system comprising:
a cinch loop coupled to the pet carrier;
a cinch strap having a proximal end and a distal end wherein said proximal end is coupled to the pet carrier;
said cinch strap having a length sufficient to insert said distal end through said cinch loop;
means for removably coupling said distal end of said cinch strap so as to retain the seat belt.

8. The loop system of claim 7 wherein said proximal end of said cinch strap is coupled to the pet carrier a distance from the cinch loop sufficient to allow the seat belt to be positioned between said proximal end of said cinch strap and said cinch loop.

9. The loop system of claim 7 further including a carry strap coupled to the pet carrier and said cinch loop and proximal end of said cinch strap are coupled to said carry strap.

10. The loop system of claim 7 wherein said cinch loop is a slip lock buckle.

11. The loop system of claim 7 wherein said distal end of said cinch strap is looped through said cinch loop and coupled to said cinch strap.

12. The loop system of claim 11 wherein said means for removably coupling includes a hook and loop fastening system.

13. A pet carrier including a loop system to engage a seat belt of a vehicle, said pet carrier comprising:
a flexible housing for holding and transporting an animal;
said housing including a substantially rectangular bag having a bottom panel, two elongated side panels and two short side panels;
at least one anchor tab coupled to one of said two elongated side panels of said flexible housing;
a cinch loop coupled to said at least one anchor tab;
at least one cinch strap having a proximal end and a distal end wherein said proximal end is coupled to one of said two elongated side panels adjacent said anchor tab;
said at least one cinch strap having a length sufficient to insert said distal end through said cinch loop;
a coupling mechanism to removably couple said distal end of said cinch strap to said cinch strap so as to engage the seat belt between said flexible housing and said cinch strap.

14. The pet carrier of claim 13 further including at least one carry strap coupled to said flexible housing.

15. The pet carrier of claim 14 wherein at least one carry strap is coupled to each of said two elongated side panels.

16. The pet carrier of claim 15 wherein said at least one anchor tab and said proximal end of said at least one cinch strap is coupled to said at least one carry strap.

17. The pet carrier of claim 15 further comprising:
each of said at least one carry strap includes a first end and a second end;
a first end of each of said at least one carry strap being coupled to each of said two elongated side panels adjacent one of said two short side panels;
a second end of said at least one carry strap being coupled to each of said two elongated side panels adjacent one of said two short side panels;
one of said at least one anchor tab and one proximal end of said at least one cinch strap being coupled to said carry strap adjacent said first end
one of said at least one anchor tab and one proximal end of said at least one cinch strap being coupled to said carry strap adjacent said second end.

18. The pet carrier of claim 17 wherein one of said at least one anchor tab and one proximal end of said at least one cinch strap being coupled to said carry strap adjacent said second end.

19. The pet carrier of claim 13 wherein said distal end of said cinch strap is looped through said cinch loop and coupled to said cinch strap.

20. The pet carrier of claim 19 wherein said means for removably coupling includes a hook and loop fastening system.
